(19) United States
(12) Patent Application Publication
(10) Pub. No.: US 2014/0168436 A1
(43) Pub. Date: Jun. 19, 2014

(54) LICENSE PLATE INTEGRATION & COMMUNICATION SYSTEM

(71) Applicant: Adam Pedicino, Dedham, MA (US)

(72) Inventor: Adam Pedicino, Dedham, MA (US)

(21) Appl. No.: 13/717,015

(22) Filed: Dec. 17, 2012

(51) Int. Cl. G06K 9/32; H04N 7/18; G06Q 40/08

(52) U.S. Cl. CPC G06K 9/3258; G06Q 40/08; H04N 7/18
USPC 348/148; 705/4; 382/105

(57) ABSTRACT

A method of posting information to an online database regarding driving behavior of motorists is provided. The posting is based on identifying driver's by license plate number. The online database may be accessible by the public, registered website users, insurance companies, and/or law enforcement.

### BACKGROUND OF THE INVENTION

1. Field of the Invention

The present invention relates generally to online identification systems. More particularly the present invention relates to a system to identify vehicles by license plate number that allows users to post comments and information about identified license plate numbers.

2. Description of Related Art

The use of Facebook®, Twitter®, and Instagram® have recently impacted our society by allowing communication from user to user over a common goal, frustration, interest, or similarity. But what is it about these blogging websites and apps has our society so addicted that we can't seem to break away from them? One theory is that the instant gratification of “I need my thoughts and ideas heard” is the driving force of our society's social media addiction. Social media allows for a cause such as genocide, politics, as well as natural catastrophes to be heard by its users, however the idea of “my needs” are still the dominating trending theme.

The final frontier in the social media lies in the ability to report unsafe habits to keep the public safe. Because drivers believe only police officers can issue a ticket it is only important to drive safely when they are around. As a result, there is no accountability to avoid aggressive or dangerous driving.

Therefore what is needed is a system that may be utilized to keep our roads safe. This system need not be limited to fellow motorists. Instead, it may encompass all people who use our roads. From pedestrians to cyclists to even the neighborhood dog walker. The system desired may be used to report drivers who only care about their own personal safety, among other things. One method of identifying otherwise anonymous drivers is by license plate number.

### SUMMARY OF THE INVENTION

The subject matter of this application may involve, in some cases, interrelated products, alternative solutions to a particular problem, and/or a plurality of different uses of a single system or article.

In one aspect, a license plate based identification system is provided. The system comprises a user-accessible computerized online database which may receive and store tags relating to license plates of vehicles and their driving behaviors, the tags will be used predominately to report driving incidents, either good or bad. The tags comprise information including a license plate number of the vehicle being reported, and an additional item of information such as a comment about the driving incident.

A user interface may be in network communication with the computerized online database. The user interface is configured to allow uploads of tags by a user of the system.

An insurance company interface is also in communication with the computerized online database. The insurance company interface allows an insurance company to access the computerized online database and access posted tags.

In another aspect, a method of tracking a driver's driving style by an insurance company is provided. The method involves providing a computerized online database allowing a user to post a tag to the database comprising a comment about a driving incident and a license plate number of a vehicle causing the driving incident. The license plate number corresponds either to a vehicle insured by the insurance company, or a vehicle that potentially may be insured by the insurance company.

The method further comprises the step of displaying the tag on a website that accesses the computerized online database. Drivers are incented to drive safely by the insurance company providing a decreased insurance premium if a driver's vehicle's license plate number is untagged or maintains a number of tags below a target number. The target number may be any number of tags as determined by the insurance company.

In yet another aspect, a method of notifying an authority of a driving incident is provided. Initially a user identifies a driving incident involving a vehicle, and the vehicle's license plate number. This information may be inputted into a tag and posted to a computerized online database using a user interface. The tag information will comprise the license plate number and a comment. The computerized online database may be accessible to an authority such as law enforcement or an insurance company. The authority may access the tag data and act accordingly.

### BRIEF DESCRIPTION OF THE DRAWINGS

FIG. 1 provides a flow chart of an embodiment of a method of using the system.

FIG. 2 provides a view of an embodiment of the system.

FIG. 3 provides a view of an embodiment of the tag and inputs that may be included in the tag.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a license plate identification system that may be utilized to “tag” drivers based on license plate information. The system may be computerized such that the tagging may be uploaded to an online database and displayed on a website, or other public forum. Displaying tags allows viewing of tag records by the driver corresponding to the tagged license plate, as well as viewing by others. In particular, the system may allow viewing by an insurance company. The goal of the license plate identification system is to increase driver accountability, allow drivers to directly impact their insurance premium by avoiding being “tagged,” and to allow insurance carriers to more closely view driving habits of their insured, among others.

The system contemplated herein may comprise three major elements working either independently or in tandem. One element is the website and corresponding online database. Another element is a mobile application interface using an internet enabled mobile device. Another element is a vehicle mounted camera with access to the system either directly, or through a network connection.

The website and corresponding online database allow posting of a license plate number and optionally its U.S. State in conjunction with a tag. The tag may comprise comments and additional information such as an accused infraction, accident details, report of a good act, general comments, and the like. Further the website may provide a driver access to his or her own license plate record to view if it has any tags. In one embodiment, the website may allow a driver access to the license plate records of others to view their tags. Further, a user of the system need not be a driver. Other users may include cyclists, motorcyclists, pedestrians, observers, comments, and the like. Indeed, anyone who may view a driver's behavior may use system to identify the license plate number of their vehicle and optionally State, and upload a tag.

Other examples of additional information that may be included in a tag may include a date stamp, a time stamp, GPS or other location data, an account of the events, a photo of the event, a video of the event, and the like. This information may be included in a tag in addition to the license plate number to provide a more detailed tag.

In one embodiment, an insurance company may access the tags and other information on the website's database. The insurance company may have access to tags for license plates of its insured or potential insured. The insurance company may use this data for any number of reasons including viewing the driving behavior and style of an insured, and researching a situation surrounding an accident, arrest, or other driving incident. Insurance companies may find this data useful for lawsuits, determining claim payouts, evaluating a driver for an insurance premium, or adjustment of insurance premium (either up or down), among others. In a further embodiment, the website and database may be managed and hosted by an insurance company.

In one embodiment, the insurance company may access data relating to a driving incident while the data remains the property of a system user. For example, while the insurance company may access the data, it may not further distribute the information without user consent. A user may then be able to control distribution of the information including, but not limited to, selling the data, creating derivative works based on it, and other related uses. In a further embodiment, the insurance company may have a limited license of the data posted by a user for use in court proceedings, premium setting, settlement discussions, and the like.

In another embodiment, police and law enforcement may access tags and other information on the website's database. This information may be used in police reporting, criminal prosecution, surveillance, and the like. In one embodiment, posted information may be directly transmitted to a law enforcement agency. In yet another embodiment, posted information may be accessible to law enforcement and a flag or notification may be sent to the law enforcement to alert them of potentially valuable information. In addition a system may be provided to submit anonymous video, photographic, or other evidence either directly to law enforcement, or to the online database.

In still a further embodiment, the system may be configured to allow insurance companies and/or law enforcement to utilize GPS data of a tag to identify additional information provided by other users of a driving incident. In this embodiment, a user may post a tag of a driving incident. Upon viewing, an insurance company or law enforcement agency may desire additional gathered information. As such, they may access the database, and search by GPS location data to see if any further information has been posted to the database in the form of a tag, or data stored on the database but not posted in a tag. In another embodiment, an insurance company or law enforcement agency may access a data storage unit of a user's system that may store un-tagged but relevant information such as images, video, and the like. Based on GPS data, the insurance company or law enforcement agency may be able to gather data for even non-tagged events, or an event tagged by one user but not another. In a further example, in an embodiment wherein a video recording camera is recording data in a loop, the insurance company or law enforcement agency may access this recorded loop without user interaction and directly gather data.

In one embodiment, allowing the insurance company or law enforcement to access data other than what has been tagged may be an opt-in option. In another embodiment it may be automatic. In still another embodiment, it may be allowed by default but a user may opt-out. In further embodiments, a user may be provided a discounted insurance premium in response for participation in the program allowing the insurance company or law enforcement to access data other than what has been tagged may be an opt-in option.

The website may have an enrollment feature to allow users to sign up and access the website database, and/or to provide additional features compared to a non signed-in user. In one embodiment, a user may sign in on their own by creating, for example, a user name and password. In another embodiment, users may be automatically enrolled by their insurance company. In this embodiment, the users may be provided a default user name and password. In still another embodiment, a user may be “soft” enrolled by their insurance company to get their information into the system and allow the user limited access. The user may then “hard” enroll by formally signing up and selecting, for example, a user name and password.

In use, a website user may access the website and post a tag comprising at least a license plate number. In one embodiment, a user may be required to be logged in to post. This posting may be anonymous in one embodiment, or identifiable in another embodiment. The identification may be by user name, actual name of the user, or the like.

In one embodiment, to prevent contentious encounters and/or “road rage,” the system may include a delay feature that automatically delays access to a tag for a specified period of time.

In another embodiment of use of the system may include a direct connection function to allow a tagger to communicate with a person who was tagged and vice versa. This function may allow communication between the parties to potentially get a negative tag removed. In a particular embodiment, there may be, in addition or in alternative to written communication, a series of pre-programmed responses. For example these responses may include an “I'm sorry”, “I disagree”, “Leave me alone”, and the like.

In a further embodiment of use, the system may include a dispute function allowing a user who has been negatively tagged to dispute the tag. This dispute function may be implemented to prevent abuse of the system.

In further embodiments, an insurance company user interface to the online database may be configured to deflect fraudulent taggings to prevent abuse of the system. Fraudulent taggings may be re-postings of a single incident, overly abusive or negative comments, unrelated taggings, a mis-tag, and the like. In one embodiment, this may be a passive operating system that uses filters, algorithms and/or heuristics to detect and flag or eliminate fraudulent taggings. In another embodiment, an active operating system may be used to work collaboratively with the database and website to prevent fraudulent tagging. The active operating system may use the passive strategies as noted above for the passive system, and may also involve active involvement and monitoring by system administrators and collaboration between the online system and the insurance company.

In still a further embodiment, an algorithm may be implemented to filter excessive negative comments and other “spam”, or other abuse of the system.

In yet a further embodiment of use, the system may include an interactive forum on the website to encourage discussion among users, answer questions, provide opinions, allow users to comment, and the like.

The mobile application element of the system may allow users to utilize internet enabled mobile devices to post license plates and tags to the website. This element involves the integration of the internet enabled mobile device with the website to facilitate rapid posting while users are out and about.

The term internet enabled mobile device is used herein to mean any internet enabled mobile computer. These may include, among others, internet enabled cellular phones, including “smart phones” such as IPhone®, Blackberry®, or Android® OS devices, tablet devices, iPod Touch®, tablet computers such as IPad®, personal digital assistants (PDAs) and similar portable, handheld devices.

In one embodiment, the internet enabled mobile device may be configured to interface with the website and corresponding online database. Further, a camera of the internet enabled mobile device may be utilized to capture images and/or video of events. The device may be configured to couple this captured images/video and upload it in a tag along with license plate information either automatically or as commanded by a user. In one embodiment, the camera may be configured to identify and focus directly on a license plate.

In a further embodiment, the internet enabled mobile device may comprise a global positioning system (GPS) allowing a user to include, manually or automatically, GPS data of the location in the tag.

In yet another embodiment, the internet enabled mobile device may be configured to use a clock and/or calendar to include date and time information in the tag, either manually or automatically.

In still another embodiment, the internet enabled mobile device may be configured to provide mobile alerts regarding a user's account. For example, if a user's license plate is tagged, the system may provide an alert to a user's internet enabled mobile device. Further, alerts may be provided upon comments about a tag, upon feedback, to provide general alerts, or to provide alerts regarding local accidents, dangerous drivers, and the like.

The vehicle mounted camera(s) element may be utilized to visually record events that occur during driving. These visual records may be incorporated into a tag and posted to the system's website.

In one embodiment, the vehicle mounted camera may comprise a transmitter capable of transmitting video or image data directly to the website either automatically or upon command by a user. In another embodiment, the vehicle mounted camera may communicate directly with a user's mobile device and indirectly to the online database through a user's data plan. The vehicle mounted camera may further comprise a data storage unit. The data storage unit allows the camera to store video and image data for a period of time until it is desired to be retrieved. In varying embodiments, the data storage unit may be located within the vehicle, either integrated into the camera housing, or in a separate area of the vehicle, or may be off site and in communication with the camera via the transmitter.

In one embodiment, the data storage unit may operate as a “black box” and may record other data relating to vehicle operation including, but not limited to, engine operation logs, impact data from an impact sensor, maintenance records, and the like.

In an embodiment wherein the on-board camera is configured to transmit an image or video recording to an off site storage unit, the on-board camera may further comprise a transmitter to transmit the data directly to the off site storage unit. In one embodiment, a user's mobile device data plan may act as the transmitter. In another embodiment, the transmitter may transmit directly using a wireless service to the off site data storage unit. In this embodiment, an insurance company may provide the service to allow the transmitter to operate. In one embodiment the insurance company may provide a corporate wireless communication system with a very high or unlimited use cap to allow large volumes of data (such as high definition video) to be transferred. In a still a further embodiment the communication system provided by the insurance company may act as a “hotspot” allowing people in the vehicle to connect it via a Wi-Fi connection to access the internet directly through the insurance company provided communication system.

The camera contemplated herein may be any camera capable of capturing images and/or videos. In one embodiment, the camera may be a 360 degree camera capable of viewing all about a vehicle. In another embodiment, a forward facing camera may record what occurs in front of a vehicle. In yet another embodiment, the camera may comprise multiple cameras to record at different angles. In still another embodiment, the system may utilize an internet enabled mobile device having a camera as the integrated camera. An example of this embodiment may involve the internet enabled mobile device positioned in a stand such that its camera is facing towards a windshield of a vehicle.

In one embodiment using a video recording camera, the video data may be stored in a loop cycle of a certain time period. Once a record command is initiated, the data storage unit is directed to permanently store a time period before and after the record command. The record command may be initiated by a user, or automatically, in varying embodiments. The time periods contemplated herein may vary, however in one embodiment, a 30 minute loop may be used. Upon recording, the data storage unit may store ten minutes before the tag and twenty minutes after.

Once stored in the data storage unit, the video (or images) may be sent to the website database, to a separate server, or to a user's internet enabled mobile device. Generally, the data may be intended to be used in a tag coupled with a license plate number. However, in some embodiments, a user may choose not to upload the recorded data.

In one embodiment, the vehicle mounted camera may be an after-market addition to the vehicle. In another embodiment, the vehicle may be manufactured with the camera integrated therein.

In a further embodiment, the camera may be lockable or activatable by the internet enabled mobile device.

In one embodiment, upon storage of the video or image data on a computer accessible data storage unit, a computerized algorithm may be used to automatically identify a license plate number and optionally, the issuing state. This embodiment may increase the ease of use of the system and the speed and ease which tagged information may be uploaded to the website's database.

In one embodiment, the camera may be capable of a passive use mode. The passive use mode takes place when the vehicle is not operation. In this mode, an accelerometer or similar motion sensor may be configured to sense an impact on the vehicle and activate the camera automatically. This activation may be for a set time period in one embodiment, or may record until a user shuts it off manually.

In a further embodiment, a passive mode camera activation may further include sending an alert to a user's internet enabled mobile device. The alert may include information such as the fact that the camera was activated, an option to alert the authorities, a still image of the vehicles surroundings at activation, a video of the vehicle's surroundings at activation, GPS location of the vehicle, and the like.

The use of the camera up to this point may be considered use of the camera in “active mode.” In the active mode, the camera may be activated as soon as the engine is running, drawing power from the vehicle electrical system, or the camera may be manually activated by a user at any time. Further the camera may be connected to a record button. The record button may be any interface that triggers a recording of the camera and storage. The record button may be any structure capable of instructing the camera to save a recording, such as a physical push-button, an interface with the vehicle's on board computer such as a touch screen, a touch screen of a internet enabled mobile device, an audio sensor, or a button on the camera itself.

In another embodiment, the record command of the camera may be automatically triggered in the event of an impact to the vehicle. The impact may be measured by, for example, an accelerometer that may detect crash level impacts, and send a signal to the camera, which will initiate a recording to store images and/or video before and after impact.

In addition to the uses described above for the image and video used in the tagging, the recorded data can be sent in a police report, insurance claim, or stored for a driver's personal records.

In one embodiment, the interface of an internet enabled mobile device may be configured to be voice activated and controllable. Further, the system may be fully automated to post tags to either the database directly, or a queue of the user's account for later posting, automatically, with minimal or no user actions. Automatic processing and posting, along with voice activation, may be especially applicable to use while driving to prevent a user from becoming distracted.

In another embodiment, the interface of the internet enabled mobile device may automatically activate when the mobile device is within a certain close range to the vehicle.

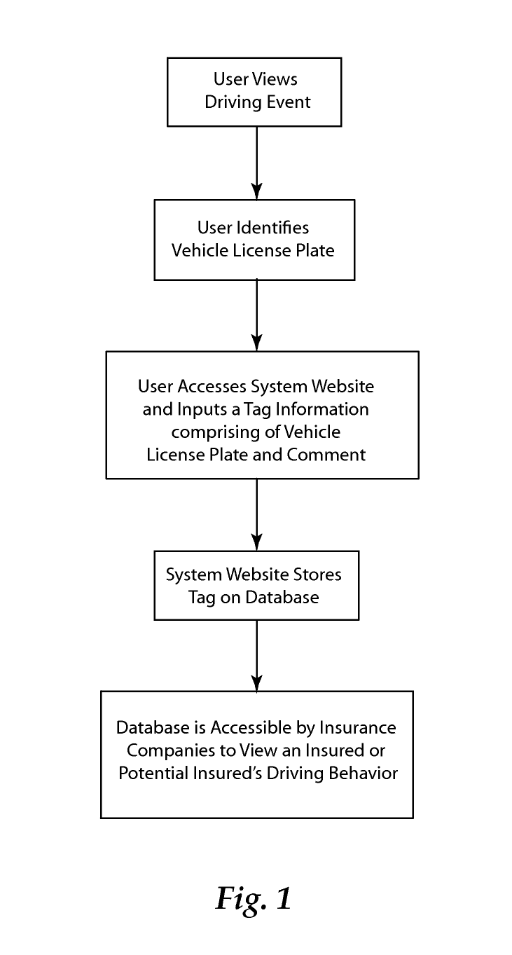

Turning now to FIG. 1, a flow chart of an embodiment of a method of using the system is provided. In this embodiment, the user may view a driving incident, such as aggressive driving, an accident, a good driving act, irresponsible or dangerous driving, and the like. Once the driving incident is viewed by the user, the user may identify the license plate of the vehicle or vehicles involved in the driving incident. The user may then access the system website or directly connect to the online database, and upload a tag. The tag comprises information regarding the driving incident and the license plate number. The information may include a summary or comments, a photo or video, location, time and date, and the like, as further noted in this disclosure. The system website and corresponding online database may then store this tag information, which may be accessible to others. Those who may access stored tag information include, but are not limited to, the public, logged in users, insurance companies, and/or law enforcement agencies. In particular, an insurance company may use this tagging system to monitor the driving behavior of an insured or a potential insured.

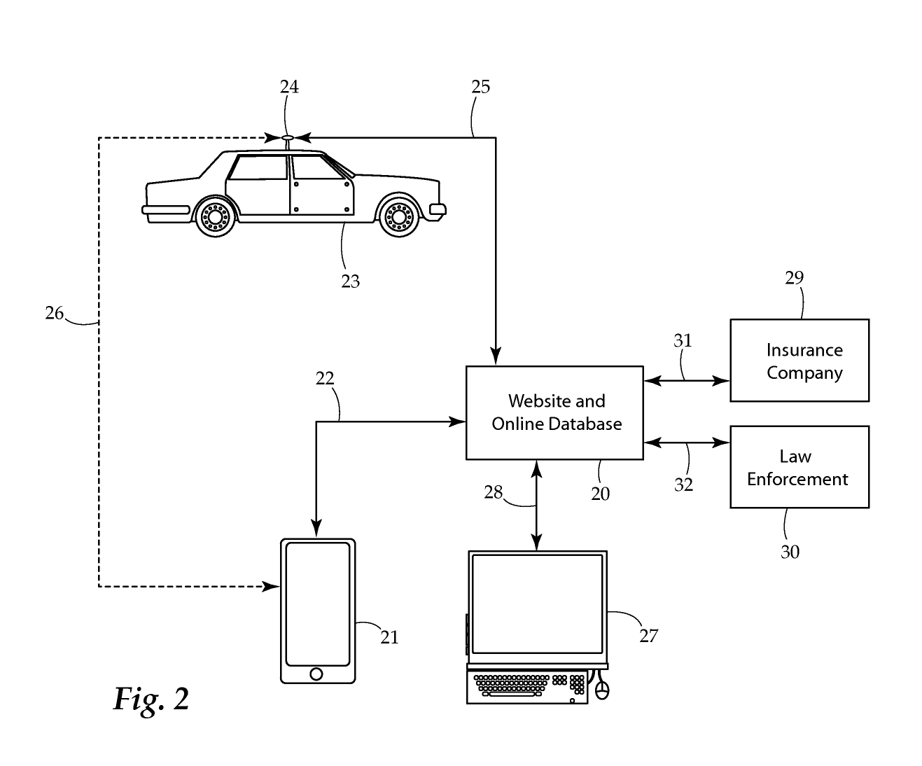

FIG. 2 shows a view of an embodiment of the system. At the center of the figure is the website and online database 20. The website and online database 20 is in communication with a number of sources. An internet enabled mobile device 21 is in communication with the website and online database 20 via wireless network 22. A computer 27 is in communication with the website and online database 20 via network communication (wireless or wired) line 28. The internet enabled mobile device 21 or computer 27 may be used by a user to upload a tag to the website and online database 20 identifying a vehicle by license plate number, and providing a comment regarding the vehicle's driving actions. The internet enabled mobile device 21 and computer 27 may both send and receive data from the website and online database 20.

FIG. 2 further shows a user's vehicle 23 equipped with an on-board camera 24. The on-board camera 24 is configured to communicate directly with the website and online database 20 via networked connection 25, directly with the internet enabled mobile device 21 via network connection 26, or both, via networked connections 25 and 26. The on-board camera may be configured to continuously record video, periodically record still images, record video when activated, record images when activated, or any combination thereof, as further described above.

In varying embodiments, different groups or individuals may access the tags stored on the website and online database 20. In one embodiment, a user may view tags related to his or her license plate number. In another embodiment the public may view tags about any license plate number. In yet another embodiment, logged in user may view tags about any license plate number. These groups may send and receive data from the website and online database 20, and may access the data via the internet enabled mobile device 21 or computer 27.

Further still, various entities may view the tags stored on the website and online database 20. In particular, as shown in FIG. 2, an insurance company 29 may access the website and online database 20 via networked connection 31. In addition, a law enforcement agency 30 may access the website and online database 20 via networked connection 32. The insurance company 29 and/or law enforcement agency 30 may access the website and online database 20 to identify driving behaviors of users, collect evidence and other information in the event of an accident or the like, and evaluate a driver for an insurance premium. The insurance company 29 and law enforcement agency 30 may both send and receive data to the website and online database 20.

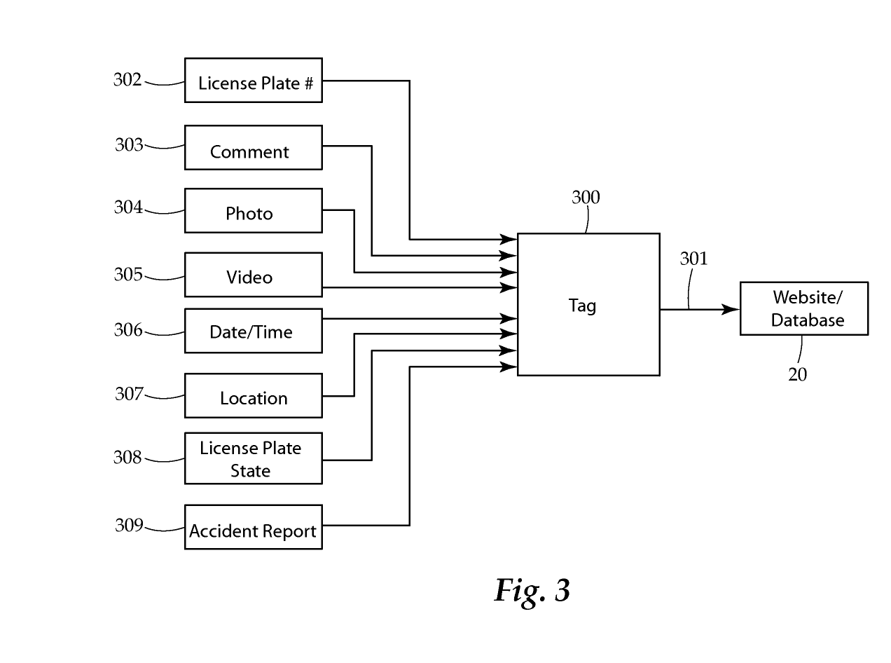

FIG. 3 provides a view of an embodiment of the tag and inputs that may be included in the tag. The tag 300 is posted to the website and online database 20 via path 301. The tag may be sent by an internet enabled mobile device (not shown) or by a computer (not shown). The tag 300 may have a number of inputs that will be included in the tag 300 when posted to the website and online database 20. These inputs may include: license plate number 302 of a vehicle involved in a driving incident, comments about the driving incident the tag 300 is relating to, a photo 304 of the driving incident, a video of the driving incident 305, the date and time of the driving incident 306, the location of the driving incident 307, the state of the license plate 308, and an accident report 309 if applicable.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A license plate identification system comprising:
a computerized online database;
a user interface in networked communication with the online database, the user interface allowing upload of a tag to the online database, the tag comprising a license plate number and an item of additional information; and
an insurance company interface, the insurance company interface in networked communication with the online database, the insurance company interface allowing an insurance company to access the online database to identify tags relating to the license plate number.

2. The license plate identification system of claim 1 wherein the user interface allowing is an internet enabled mobile device comprising a camera, the internet enabled mobile device configured to allow uploading of the tag comprising the license plate number and further comprising an image from the camera.

3. The license plate identification system of claim 2 wherein the internet enabled mobile device is configured to automatically identify and extract a license plate number from the image from the camera, the extracted license plate number incorporated into the tag.

4. The license plate identification system of claim 1 further comprising a vehicle on-board camera, the vehicle on-board camera connectable to the user interface, the on-board camera configured to allow uploading, through the user interface, of the tag comprising the license plate number and an image from the camera.

5. The license plate identification system of claim 4 wherein the user interface is a computer configured automatically to identify and extract a license plate number from the image from the camera, the extracted license plate number incorporated into the tag.

6. The license plate identification system of claim 4 wherein the user interface is an internet enabled mobile device and the on board camera is in networked communication with the internet enabled mobile device.

7. The license plate identification system of claim 4 wherein the on-board camera is in electronic communication with a motion sensor mounted on the vehicle, the on-board camera configured to record an image upon a signal from the motion sensor.

8. The license plate identification system of claim 1 further comprising a law enforcement interface, the law enforcement interface allowing a law-enforcement agency to access the online database to identify tags relating to the license plate number.

9. The license plate identification system of claim 1 wherein the item of additional information included in the tag is at least one of: a global positioning system location, a date, a time, an image, a video, and an accident report.

10. A method of tracking a driver's driving style by an insurance company comprising the steps of:
providing a computerized online database allowing a user to post a tag comprising a comment about a driving incident and a license plate number of a vehicle causing the driving incident, the license plate number corresponding to one of: a vehicle insured by the insurance company, or a vehicle potentially insured by the insurance company;
displaying the tag on a website, the website in communication with the computerized online database; and
encouraging an insured driver to drive safely by providing a decreased insurance premium if there are under a target number of tags corresponding to a license plate number of the driver's vehicle.

11. The method of tracking a driver's driving style by an insurance company of claim 10 further comprising the step providing a delay between the posting of the tag and the displaying of the tag by the computerized online database.

12. The method of tracking a driver's driving style by an insurance company of claim 10 further comprising the step of signing up the license plate number of the driver's vehicle insured by the insurance company with the computerized online database; and
providing the driver with information regarding the computerized online database.

13. The method of tracking a driver's driving style by an insurance company of claim 10 wherein the steps of:
providing an online computerized database further comprises the step of providing access to the database by an internet enabled mobile device configured to interface with the computerized online database; and
allowing posting of the tag using the internet enabled mobile device.

14. The method of tracking a driver's driving style by an insurance company of claim 10 further comprising the step of receiving an image by the computerized online database as part of the tag.

15. The method of tracking a driver's driving style by an insurance company of claim 10 further comprising the step of notifying an insured, by the computerized online database, when a tag comprising the license plate number of the driver is posted, the driver being insured by the insurance company.

16. A method of notifying an authority of a driving incident comprising the steps of:
identifying a driving incident involving a vehicle by a user;
identifying a license plate number of the vehicle;
uploading a tag into a computerized online database using a user interface, the tag comprising the license plate number and a comment, the computerized online database being accessible by an authority.

17. The method of notifying an authority of a driving incident of claim 16 further comprising the step of sending the tag automatically to the authority by the computerized online database.

18. The method of notifying an authority of a driving incident of claim 17 wherein the authority is at least one of an insurance company and a law-enforcement agency.

19. The method of notifying an authority of a driving incident of claim 16 wherein the step of uploading the license plate number and comment into a computerized online database further comprises using an internet enabled mobile device to upload the tag, the internet enabled mobile device in communication with the computerized online database, the method further comprising the steps of:
uploading automatically the tag comprising an image capture in the event of a vehicle crash by the user, the vehicle crash being recorded by a motion detector mounted within the vehicle;
detecting, using the internet enabled mobile device, a license plate number of a vehicle in the image captured.

20. The method of notifying an authority of a driving incident of claim 18 further comprising the step of recording a video using a camera of the internet enabled mobile device; and
including the video recorded in the tag.
